(19) United States
(12) Patent Application Publication
(10) Pub. No.: US 2018/0287500 A1
(43) Pub. Date: Oct. 4, 2018

(54) DC-DC CONVERTER

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD.

(72) Inventors: Shinsuke Tsutsui, Yokkaichi, Mie (JP); Seiji Takahashi, Yokkaichi, Mie (JP); Takanori Itou, Yokkaichi, Mie (JP)

(21) Appl. No.: 15/765,891

(22) PCT Filed: Aug. 31, 2016
(86) PCT No.: PCT/JP2016/075422

§ 371 Date: Apr. 4, 2018

(30) Foreign Application Priority Data
Oct. 14, 2015 (JP) 2015-202646

(51) Int. Cl. H02M 3/158; H02M 1/32

(52) U.S. Cl. CPC H02M 3/1588; H02M 1/32; H02M 2001/0003; H02M 2001/325; H02M 3/1584

(57) ABSTRACT

Provided is a multiphase DC-DC converter having a plurality of voltage conversion units, and detect an abnormality in any phase and to remain activated with a phase other than the faulty phase while the faulty phase is reliably protected. A DC-DC converter includes a plurality of voltage conversion units that are in parallel between an input-side conductive path and an output-side conductive path. Each of the voltage conversion units includes on an individual input path, a protective switch element, and a protective switch element disposed on an individual output path. The DC-DC converter further includes a protective abnormality identifying unit configured to identify a range in which a protective switch element is abnormal, and an operation control unit configured to cause, if the range in which a protective switch element is abnormal has been identified, any remaining conversion unit other than the range to perform a voltage conversion operation.

### CROSS-REFERENCE TO RELATED APPLICATIONS

This application is the U.S. national stage of PCT/JP2016/075422 filed Aug. 31, 2016, which claims priority of Japanese Patent Application No. JP 2015-202646 filed Oct. 14, 2015.

### TECHNICAL FIELD

The present invention relates to a DC-DC converter.

### BACKGROUND

Multiphase DC-DC converters that have a configuration in which a plurality of voltage conversion units are connected in parallel to each other are known as DC-DC converters that drive switch elements to step up or down a DC voltage. Examples of this type of multiphase DC-DC converter include a technique as disclosed in JP 2013-46541A.

Meanwhile, in such a multiphase DC-DC converter, there may be a case where only one phase fails, and if one phase fails, it may be preferable to continue the operation using a phase that has not failed, instead of halting the entire operation of the DC-DC converter. A power supply device of JP 2013-46541A addresses this need, and is configured to acquire electric current values that are detected by an electric current detector at timings of falling edges of control signals that are applied to switch elements of respective phase chopper units, and to determine that one of the phase chopper units has failed if the acquired current values are different. Even if it is detected that one of the phase chopper units has failed, the operation of a phase chopper unit that has not failed is continued, and an output of a power generator is restricted so as not to exceed a withstanding electric current of the phase chopper unit that has not failed.

However, the power supply device of JP 2013-46541A merely restricts the entire output if an open-circuit fault has occurred in any of the switch elements of the phase chopper units, and does not include the idea of correctly identifying a portion where the fault has occurred, and reliably disabling the operation of this portion.

The present invention was made in view of the above-described circumstances, and it is an object thereof to provide a multiphase DC-DC converter that is provided with a plurality of voltage conversion units, and has a configuration in which, if an abnormality has occurred in any phase, the multiphase DC-DC converter can be kept activated with a phase other than the faulty phase while the faulty phase is reliably protected.

### Solution to Problem

According to a first invention, a DC-DC converter includes:

a multiphase conversion unit that is provided with a plurality of voltage conversion units that are arranged between an input-side conductive path and an output-side conductive path, each voltage conversion unit including an individual input path connected to the input-side conductive path, a conversion operation portion configured to convert a voltage input to the individual input path using an on/off operation of a driving switch element, and an individual output path serving as an output path for the voltage converted by the conversion operation portion, each voltage conversion unit being provided with, on at least one of the individual input path and the individual output path, a protective switch element configured to switch the corresponding individual input or output path between a conductive state and a non-conductive state;

a detection unit configured to detect that an abnormality has occurred in the multiphase conversion unit at least during an operation of the multiphase conversion unit;

a disabling control unit configured to disable all of the voltage conversion units of the multiphase conversion unit if the occurrence of an abnormality in the multiphase conversion unit is detected by the detection unit during the operation of the multiphase conversion unit;

a driving abnormality identifying unit configured to identify, at least after all of the voltage conversion units are disabled by the disabling control unit, a conversion unit that is abnormal or a group including a conversion unit that is abnormal from among the plurality of voltage conversion units that constitute the multiphase conversion unit; and

an operation control unit configured to cause, if a conversion unit that is abnormal or a group including a conversion unit that is abnormal is identified by the driving abnormality identifying unit, any remaining conversion unit other than the conversion unit or the group including the conversion unit that has been identified by the driving abnormality identifying unit to perform a voltage conversion operation.

According to a second invention, a DC-DC converter includes:

a multiphase conversion unit that is provided with a plurality of voltage conversion units that are arranged between an input-side conductive path and an output-side conductive path, each voltage conversion unit including an individual input path connected to the input-side conductive path, a conversion operation portion configured to convert a voltage input to the individual input path using an on/off operation of a driving switch element, and an individual output path serving as an output path for the voltage converted by the conversion operation portion, each voltage conversion unit being provided with, on at least one of the individual input path and the individual output path, a protective switch element configured to switch the corresponding individual input or output path between a conductive state and a non-conductive state;

a protective abnormality identifying unit configured to identify at least either a conversion unit in which a protective switch element is abnormal, or a group including a conversion unit in which a protective switch element is abnormal, from among the plurality of voltage conversion units that constitute the multiphase conversion unit; and

an operation control unit configured to cause, if a conversion unit in which a protective switch element is abnormal or a group including a conversion unit in which a protective switch element is abnormal is identified by the protective abnormality identifying unit, any remaining conversion unit other than the conversion unit or the group including the conversion unit that has been identified by the protective abnormality identifying unit to perform a voltage conversion operation.

In the DC-DC converter according to the first invention, the plurality of voltage conversion units constituting the multiphase conversion unit are each provided with, on at least one of the individual input path and individual output path, a protective switch element configured to switch the corresponding individual input or output path between a conductive state and a non-conductive state. In this way, a protective switch element is provided individually for each phase, and thus, if an abnormality has occurred in a phase, the protective switch element easily conducts appropriate protection.

Furthermore, the DC-DC converter according to the first invention is provided with: a detection unit configured to detect that an abnormality has occurred in the multiphase conversion unit at least during an operation of the multiphase conversion unit; and a disabling control unit configured to disable all of the voltage conversion units of the multiphase conversion unit if the occurrence of an abnormality in the multiphase conversion unit is detected by the detection unit during the operation of the multiphase conversion unit. With such a configuration, if an abnormality has occurred during the operation of the multiphase conversion unit, it is possible to temporarily disable all of the voltage conversion units to conduct prompt protection.

Also, in the DC-DC converter according to the first invention, after all of the voltage conversion units are disabled by the disabling control unit, the driving abnormality identifying unit can identify a conversion unit that is abnormal or a group including a conversion unit that is abnormal, from among the plurality of voltage conversion units constituting the multiphase conversion unit. Particularly, since all of the voltage conversion units are temporarily disabled and then the operation shifts to an operation for identifying a range of abnormality, the identification of the range of abnormality is performed in a state in which the multiphase conversion unit is better protected. If the identification has been performed by the driving abnormality identifying unit, the operation control unit causes any remaining conversion unit other than the conversion unit or the group including the conversion unit that has been identified by the driving abnormality identifying unit to perform a voltage conversion operation. Accordingly, it is possible to continue the operation using the remaining conversion unit while reliably continuing disabling the range of abnormality (one or more phases) to protect it.

In the DC-DC converter according to the second invention, the plurality of voltage conversion units constituting the multiphase conversion unit are each provided with, on at least one of the individual input path and individual output path, a protective switch element configured to switch the corresponding individual input or output path between a conductive state and a non-conductive state. In this way, a protective switch element is provided individually for each phase, and thus, if an abnormality has occurred in a phase, the protective switch element easily conducts appropriate protection.

Furthermore, the DC-DC converter according to the second invention is provided with a protective abnormality identifying unit configured to identify at least either a conversion unit in which a protective switch element is abnormal, or a group including a conversion unit in which a protective switch element is abnormal, from among the plurality of voltage conversion units constituting the multiphase conversion unit. Accordingly, it is possible to identify a range (one or more phases) in which a protective switch element is abnormal. Also, the operation control unit is configured to cause, if a conversion unit in which a protective switch element is abnormal or a group including a conversion unit in which a protective switch element is abnormal is detected, any remaining conversion unit other than the conversion unit or the group including the conversion unit that has been identified by the protective abnormality identifying unit to perform a voltage conversion operation. Accordingly, it is possible to continue the operation using the remaining conversion unit while reliably continuing disabling the range of abnormality (one or more phases) to protect it. Particularly, it is possible to prevent a protective switch element that is abnormal from being used continuously, thus preventing such a situation that, when needed to be turned off during the voltage conversion operation of the multiphase conversion unit, a protective switch element of a phase cannot be turned off due to a failure.

### BRIEF DESCRIPTION OF DRAWINGS

FIG. 1 is a circuit diagram schematically illustrating an example of a DC-DC converter according to Embodiment 1.

FIG. 2 is a flowchart illustrating an example of a flow of test processing that is performed in the DC-DC converter of Embodiment 1.

FIG. 3 is a circuit diagram schematically illustrating an example of a DC-DC converter according to another embodiment.

### DETAILED DESCRIPTION OF PREFERRED EMBODIMENTS

Preferred embodiments of the invention will be described below.

In the second invention, each of the voltage conversion units constituting the multiphase conversion unit may be provided with protective switch elements on its individual input path and individual output path. Also, the protective abnormality identifying unit may be configured to identify a conversion unit in which at least one of the protective switch elements is abnormal, or a group including a conversion unit in which at least one of the protective switch elements is abnormal, from among the plurality of voltage conversion units constituting the multiphase conversion unit.

Accordingly, providing each of the voltage conversion units with the protective switch elements on both input side and output side makes it possible to respectively switch the input-side individual input path and the output-side individual output path to the OFF state to protect the voltage conversion unit. Accordingly, a configuration is achieved in which it is possible to perform the protection operation of preventing an electric current from flowing to a voltage conversion unit from the input side, and the protection operation of preventing an electric current from flowing backward to the voltage conversion unit from the output side. Furthermore, if a conversion unit in which at least either of the input-side and output-side protective switch elements is abnormal, or a group including such a conversion unit has been identified, it is possible to disable the identified range, and continue the operation using the remaining changing unit. With this, of the plurality of conversion units constituting the multiphase conversion unit, only the conversion unit in which no abnormality has occurred on both input side and output side will be used, and the conversion unit to be used is easily and reliably subjected to a protection operation on both input side and output side when protection is needed.

In the second invention, the protective abnormality identifying unit may be configured to identify, at least when an ignition switch is switched from OFF to ON, a conversion unit in which a protective switch element is abnormal, or a group including a conversion unit in which a protective switch element is abnormal with a subset or all of the plurality of voltage conversion units constituting the multiphase conversion unit serving as a detection target.

According to this configuration, after the ignition switch is switched from OFF to ON, a range in which a protective switch element is abnormal can be identified more promptly in an earlier stage after the activation.

In the second invention, the protective abnormality identifying unit may be configured to detect, when the ignition switch is switched from OFF to ON, a conversion unit in which a protective switch element is abnormal, or a group including a conversion unit in which a protective switch element is abnormal with a subset of the plurality of voltage conversion units constituting the multiphase conversion unit serving as a detection target, and may be configured to switch the conversion unit serving as a detection target or the group including a conversion unit serving as a detection target each time the ignition switch is switched from OFF to ON.

With this, it is possible to suppress a check time that is involved in a single ON operation of the ignition switch. Furthermore, since it is possible to check a plurality of voltage conversion units cyclopaedically in a plurality of times of ON operations of the ignition switch, it is possible to prevent such a situation that a voltage conversion unit is not checked for a long time.

The second invention may include: a detection unit configured to detect that an abnormality has occurred in the multiphase conversion unit at least during an operation of the multiphase conversion unit; a disabling control unit configured to disable all of the voltage conversion units of the multiphase conversion unit if the occurrence of an abnormality in the multiphase conversion unit is detected by the detection unit during the operation of the multiphase conversion unit; and a driving abnormality identifying unit configured to identify, at least after all of the voltage conversion units are disabled by the disabling control unit, a conversion unit that is abnormal or a group including a conversion unit that is abnormal from among the plurality of voltage conversion units that constitute the multiphase conversion unit. Furthermore, the operation control unit may be configured to cause, if a conversion unit that is abnormal or a group including a conversion unit that is abnormal is identified by the driving abnormality identifying unit, any remaining conversion unit other than the conversion unit or the group including the conversion unit that has been identified by the driving abnormality identifying unit to perform a voltage conversion operation.

According to this configuration, if an abnormality has occurred during the operation of the multiphase conversion unit, it is possible to temporarily disable all of the voltage conversion units to conduct prompt protection. Since all of the voltage conversion units are temporarily disabled and then the operation shifts to an operation for identifying a range of abnormality, the identification of the range of abnormality is performed in a state in which the multiphase conversion unit is better protected. Furthermore, if the identification has been performed by the driving abnormality identifying unit, the operation control unit causes any remaining conversion unit other than the conversion unit or the group including the conversion unit that has been identified by the driving abnormality identifying unit to perform a voltage conversion operation. Accordingly, it is possible to continue the operation using the remaining conversion unit while reliably continuing disabling the range of abnormality (one or more phases) to protect it

Furthermore, the invention using the disabling control unit may be configured to perform control such that, if the occurrence of an abnormality in the multiphase conversion unit is detected by the detection unit during the operation of the multiphase conversion unit, the protective switch elements that are respectively provided in all of the voltage conversion units are switched to an OFF state.

According to this configuration, even if a fault such as a short circuit has occurred in the driving switch element of any voltage conversion unit, it is possible to reliably disable the voltage conversion units by turning off the protective switch elements provided in the respective voltage conversion units.

Furthermore, the invention using the disabling control unit may be such that a power storage unit is connected to the output-side conductive path.

According to this configuration, even if an abnormality has occurred during the operation of the multiphase conversion unit, and all of the voltage conversion units are disabled temporarily, a voltage will continuously be output to the output-side conductive path from the power storage unit. Therefore, a configuration is achieved in which all of the voltage conversion units can be disabled if an abnormality has occurred during the operation of the multiphase conversion unit, and power supply to the output-side conductive path can be continued even while they are disabled.

In both inventions, a notification unit may be provided that is configured to give notice to the outside if at least one of the voltage conversion units of the multiphase conversion unit is restricted by the operation control unit.

According to this configuration, if at least one of the voltage conversion units of the multiphase conversion unit is restricted, an external device can recognize the situation, and can perform processing that corresponds to the restriction.

### Embodiment 1

The following will describe Embodiment 1 in which the present invention is embodied.

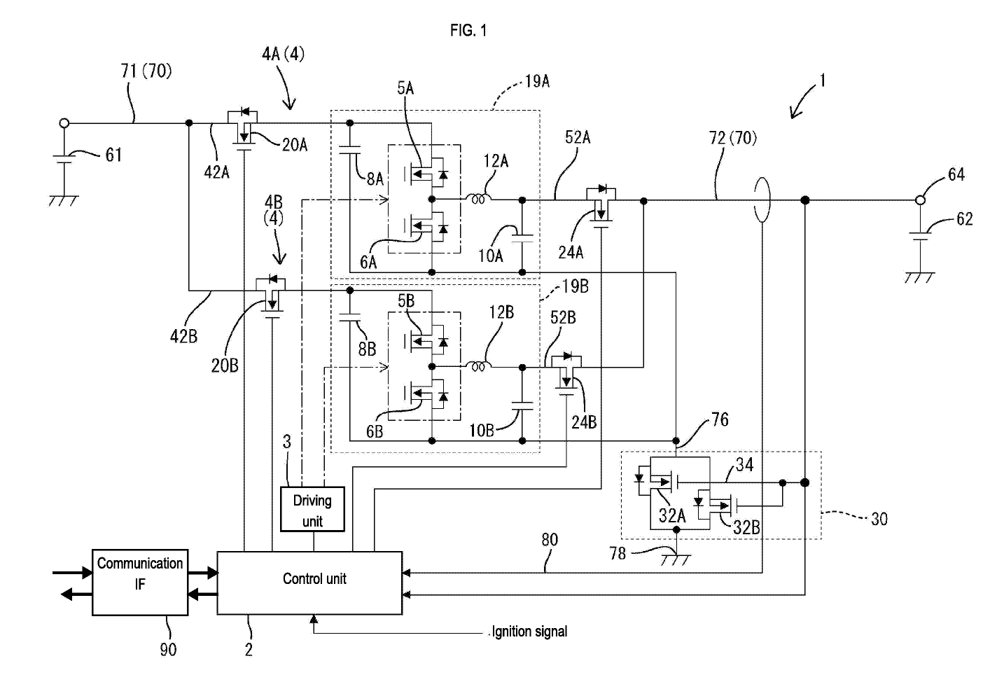

A DC-DC converter 1 shown in FIG. 1 is configured as, for example, an onboard step-down DC-DC converter, and is configured to step down a DC voltage that is applied to an input-side conductive path 71, and output the stepped-down DC voltage to an output-side conductive path 72.

The DC-DC converter 1 of FIG. 1 is provided with: a power supply conductive path 70 that includes the input-side conductive path 71 and the output-side conductive path 72, and serves as a power supply line; and a reference conductive path 78 whose electrical potential is kept at a fixed reference potential (ground potential) that is lower than an electrical potential of the power supply conductive path 70. Between the input-side conductive path 71 and the output-side conductive path 72, a plurality of voltage conversion units 4A and 4B that are configured to step down an input voltage applied to the input-side conductive path 71, and generate an output voltage are arranged in parallel.

The input-side conductive path 71 is configured as a primary side (high voltage side) power supply line to which a relatively high voltage is applied, and is conductively connected to a terminal, on a high potential-side, of a primary side power supply portion 61, so that a predetermined DC voltage (48V, for example) is applied to the input-side conductive path 71 from the primary side power supply portion 61. The input-side conductive path 71 is connected to a plurality of individual input paths 42A and 42B, which will be described later.

The primary side power supply portion 61 is constituted by, for example, an electrical storage means such as a lithium-ion battery, or an electrical double layer capacitor, and is configured to generate a first predetermined voltage. The high potential-side terminal of the primary side power supply portion 61 is kept at 48V for example, and a low-potential side terminal thereof is kept at a ground potential (0V).

The output-side conductive path 72 is configured as a secondary side (low voltage side) power supply line to which a relatively low voltage is applied. The output-side conductive path 72 is conductively connected to, for example, a terminal, on a high potential-side, of a secondary side power supply portion 62, so that a DC voltage (for example, 12V) that is lower than the output voltage of the primary side power supply portion 61 is applied to the output-side conductive path 72 from the secondary side power supply portion 62.

The secondary side power supply portion 62 is constituted by, for example, an electrical storage means such as a lead storage battery, and is configured to generate a second predetermined voltage that is lower than the first predetermined voltage that is generated by the primary side power supply portion 61. For example, the high potential-side terminal of the secondary side power supply portion 62 is kept at 12V, and a low-potential side terminal thereof is kept at a ground potential (0V). Note that “normal connection state” of the secondary side power supply portion 62 refers to a state in which, in the example of FIG. 1, a terminal 64 provided on the output-side conductive path 72 is connected to the terminal, on the positive side, of the secondary side power supply portion 62.

The reference conductive path 78 is configured as a ground, and is kept at a fixed ground potential (0V). The low-potential side terminal of the primary side power supply portion 61, and the low-potential side terminal of the secondary side power supply portion 62 are conductively connected to the reference conductive path 78, and drains of switch elements 32A and 32B, which will be described later, are connected to the reference conductive path 78.

A multiphase conversion unit 4 is provided between the input-side conductive path 71 and the output-side conductive path 72. The multiphase conversion unit 4 includes the plurality of voltage conversion units 4A and 4B that are arranged parallel to each other between the input-side conductive path 71 and the output-side conductive path 72. These voltage conversion units 4A and 4B function as synchronous rectification type step-down converters.

The voltage conversion unit 4A includes the individual input path 42A (individual conductive path) that is connected to the input-side conductive path 71, a conversion operation portion 19A configured to convert a voltage input to the individual input path 42A using on/off operations of driving switch elements 5A and 6A, and an individual output path 52A (individual conductive path) that serves as an output path for the voltage converted by the conversion operation portion 19A. Also, the individual input path 42A is provided with a protective switch element 20A for switching the individual input path 42A between a conductive state and a non-conductive state. Furthermore, the individual output path 52A is provided with a protective switch element 24A for switching the individual output path 52A between a conductive state and a non-conductive state in case of a back flow.

In the voltage conversion unit 4A, the individual input path 42A that is branched from the input-side conductive path 71 is connected to a drain of a switch element 5A on the high side. The drain of the switch element 5A is conductively connected to an electrode, on one side, of an input-side capacitor 8A, and is also conductively connected to the high potential-side terminal of the primary side power supply portion 61 when the switch element 20A located on the individual input path 42A is in an ON state. Furthermore, a drain of a switch element 6A on the low side and one end of a coil 12A are connected to a source of the switch element 5A. Electrodes of the input-side capacitor 8A and an output-side capacitor 10A are connected to a source of the switch element 6A on the low side. Furthermore, the other end of the coil 12A is connected to the other electrode of the output-side capacitor 10A and a source of the switch element 24A. Furthermore, a driving signal and a non-driving signal are input from a driving unit 3 to a gate of the switch element 5A, so that the switch element 5A switches between an ON state and an OFF state in accordance with the signal from the driving unit 3. A driving signal and a non-driving signal are also input from the driving unit 3 to a gate of the switch element 6A on the low side, so that the switch element 6A switches between an ON state and an OFF state in accordance with the signal from the driving unit 3.

The voltage conversion unit 4B has the same configuration as that of the voltage conversion unit 4A. This voltage conversion unit 4B includes an individual input path 42B (individual conductive path) that is connected to the input-side conductive path 71, a conversion operation portion 19B configured to convert a voltage input to the individual input path 42B using on/off operations of driving switch elements 5B and 6B, and an individual output path 52B (individual conductive path) that serves as an output path for the voltage converted by the conversion operation portion 19B. The individual input path 42B is also provided with a protective switch element 20B for switching the individual input path 42B between a conductive state and a non-conductive state. Furthermore, the individual output path 52B is provided with a protective switch element 24B for switching the individual output path 52B between a conductive state and a non-conductive state in case of a back flow.

In the voltage conversion unit 4B, the individual input path 42B that is branched from the input-side conductive path 71 is connected to a drain of a switch element 5B on the high side. The drain of the switch element 5B is conductively connected to an electrode, on one side, of an input-side capacitor 8B, and is also conductively connected to the high potential-side terminal of the primary side power supply portion 61 when the switch element 20B located on the individual input path 42B is an ON state. Furthermore, a drain of a switch element 6B on the low side and one end of a coil 12B are connected to a source of the switch element 5B. Electrodes of the input-side capacitor 8B and an output-side capacitor 10B are connected to a source of the switch element 6B on the low side. Furthermore, the other end of the coil 12B is connected to the other electrode of the output-side capacitor 10B and a source of the switch element 24B. Furthermore, a driving signal and a non-driving signal are input from the driving unit 3 to a gate of the switch element 5B, so that the switch element 5B switches between an ON state and an OFF state in accordance with the signal from the driving unit 3. A driving signal and a non-driving signal are also input from the driving unit 3 to a gate of the switch element 6B on the low side, so that the switch element 6B switches between an ON state and an OFF state in accordance with the signal from the driving unit 3.

The sources of the switch elements 6A and 6B, the electrodes on one sides of the input-side capacitors 8A and 8B, and the electrodes on one sides of the output-side capacitors 10A and 10B are respectively conductively connected to each other, and are connected to sources of the switch elements 32A and 32B via a conductive path 76. Drains of the switch elements 24A and 24B are conductively connected to each other, and are connected to the output-side conductive path 72.

The voltage conversion units 4A and 4B having this configuration function as synchronous rectification type step-down converters. The voltage conversion unit 4A switches the switch element 5A on the high side between the ON operation and the OFF operation in synchronization with switching the switch element 6A on the low side between the OFF operation and ON operation, so as to step down a DC voltage applied to the individual input path 42A, and output the stepped-down DC voltage to the individual output path 52A. Specifically, the driving unit 3 gives PWM signals to the gates of the switch elements 5A and 6A, so that a first state, in which the switch element 5A is in the ON state and the switch element 6A is in the OFF state, and a second state, in which the switch element 5A is in the OFF state and the switch element 6A is in the ON state, are alternately switched. As a result of such switching between the first state and the second state being repeated, a DC voltage applied to the individual input path 42A is stepped down, and the stepped-down DC voltage is output to the individual output path 52A. The output voltage of the individual output path 52A depends on the duty ratio of the PWM signals applied to the gates of the switch elements 5A and 6A.

The voltage conversion unit 4B has the same configuration, and switches the switch element 5B on the high side between the ON operation and the OFF operation in synchronization with switching the switch element 6B on the low side between the OFF operation and the ON operation, so as to step down a DC voltage applied to the individual input path 42B, and output the stepped-down DC voltage to the individual output path 52B. Specifically, the driving unit 3 gives PWM signals to the gates of the switch elements 5B and 6B, so that a first state, in which the switch element 5B is in the ON state and the switch element 6B is in the OFF state, and a second state, in which the switch element 5B is in the OFF state and the switch element 6B is in the ON state, are alternately switched. As a result of such switching between the first state and the second state being repeated, a DC voltage applied to the individual input path 42B is stepped down, and the stepped-down DC voltage is output to the individual output path 52B. The output voltage of the individual output path 52B depends on the duty ratio of the PWM signals applied to the gates of the switch elements 5B and 6B. Note that the timings at which the driving signals are given to both of the voltage conversion units 4A and 4B are not particularly limited, and it is sufficient that, for example, the operation of the voltage conversion unit 4A and the operation of the voltage conversion unit 4B are performed with their phases shifted by a well-known control method.

Furthermore, the DC-DC converter 1 of FIG. 1 is provided with a reverse connection protection circuit portion 30, which is configured such that, if the secondary side power supply portion 62 is reversely connected, then the conduction of the conductive path 76 is interrupted, preventing an electrical current from flowing into the secondary side in the case of the reverse connection. This reverse connection protection circuit portion 30 includes: the switch elements 32A and 32B for protecting from reverse connection that are arranged parallel to the conductive path 76 running between the voltage conversion units 4A and 4B and the reference conductive path 78; and a conductive path 34 that keeps the gate potentials of the switch elements 32A and 32B at the same electrical potential as that of the output-side conductive path 72. The switch elements 32A and 32B are configured to switch between an OFF state in which the conduction of the conductive path 76 is interrupted, and an ON state in which the interruption is cancelled.

In the reverse connection protection circuit portion 30, the switch elements 32A and 32B are turned on if the terminals of at least the secondary side power supply portion 62 (low voltage side power supply portion) are in a normal connection state as shown in FIG. 1. In this case, when the multiphase conversion unit 4 is not activated, the gate potentials of the switch elements 32A and 32B are substantially the same as the positive electrode potential (for example, 12V) of the secondary side power supply portion 62, and are kept in the state of being higher than the source potentials, and thus the switch elements 32A and 32B are kept in the ON state. The sources of the switch elements 6A and 6B on the low side, the input-side capacitors 8A and 8B, and the output-side capacitors 10A and 10B are all kept as being conductively connected to the reference conductive path 78. On the other hand, in a case of the reverse connection in which the terminals of the secondary side power supply portion 62 (low voltage side power supply portion) are connected in a reversed manner with its positive and negative terminals reversed, the gate potentials of the switch elements 32A and 32B are substantially the same as the negative electrode potential (for example, −12V) of the secondary side power supply portion 62, and are kept in the state of being lower than the source potentials. Accordingly, the switch elements 32A and 32B are kept in the OFF state. If the switch elements 32A and 32B are in the OFF state, then a state is realized in which the sources of the switch elements 6A and 6B, the input-side capacitors 8A and 8B, and the output-side capacitors 10A and 10B are all not conductively connected to the reference conductive path 78. Moreover, in the configuration of FIG. 1, even if the secondary side power supply portion 62 and the output-side conductive path 72 are open, the switch elements 32A and 32B will be kept in the OFF state.

The following will describe abnormality detection during a normal operation.

The DC-DC converter 1 includes a current detection path 80 for detecting an electric current flowing through the output-side conductive path 72. The current detection path 80 is a path for detecting an electric current flowing through the output-side conductive path 72 using a well-known method, and a control unit 2 recognizes a value of the current flowing through the output-side conductive path 72 based on a value input via the current detection path 80. Note that in FIG. 1, a simplified current detection path 80 is shown, but the current detection path 80 may include any of various well-known current detecting circuits serving as a specific current detecting circuit as long as the control unit 2 can recognize a value Io of the current flowing through the output-side conductive path 72.

The control unit 2 determines whether or not an overcurrent has occurred in the output-side conductive path 72. Specifically, the control unit 2 compares the value Io of the current flowing through the output-side conductive path 72 with a predetermined threshold It, and the control unit 2 determines that there is no overcurrent if Io≤It is met, and determines that there is an overcurrent if Io>It is met.

Furthermore, a voltage from the output-side conductive path 72 is also input to the control unit 2, and the control unit 2 also determines whether or not there is an overvoltage in the output-side conductive path 72. Specifically, the control unit 2 compares a value Vo of the voltage of the output-side conductive path 72 that was detected by the control unit 2 with a predetermined threshold Vt, and the control unit 2 determines that there is no overvoltage if Vo≤Vt is met, and determines that there is an overvoltage if Vo>Vt is met.

In the present configuration, the control unit 2 corresponds to an example of a detection unit, and detects that an abnormality has occurred in the multiphase conversion unit 4 by detecting the state Io>It or Vo>Vt at least during the operation of the multiphase conversion unit 4.

If the control unit 2 has detected an abnormality of an overcurrent or an overvoltage, that is, when the state Io>It or Vo>Vt is given, the voltage conversion operations of all of the plurality of voltage conversion units 4A and 4B are disabled. Specifically, the control unit 2 gives, to the driving unit 3, an instruction to stop outputting PWM signals, and the driving unit 3 stops outputting PWM signals to the switch elements 5A, 6A, 5B, and 6B. Furthermore, the control unit 2 outputs OFF signals to all gates of the switch elements 20A, 20B, 24A, and 24B. Accordingly, the switch elements 20A, 20B, 24A, and 24B are all switched to an OFF state.

In this configuration, the control unit 2 corresponds to an example of a disabling control unit, and functions to disable all the operations of the plurality of voltage conversion units 4A and 4B in the multiphase conversion unit 4 if it is detected by the detection unit during the operation of the multiphase conversion unit 4 that an abnormality has occurred in the multiphase conversion unit 4.

Accordingly, all the operations of the plurality of voltage conversion units 4A and 4B constituting the multiphase conversion unit 4 are disabled, and then a conversion unit in which at least either a current or a voltage is abnormal is identified from among the plurality of voltage conversion units 4A and 4B.

First, in a state in which only one voltage conversion unit 4A is operated, and the other one voltage conversion unit 4B is disabled, the control unit 2 determines whether or not either of an overcurrent and an overvoltage occurs in the power supply conductive path 70. Specifically, the protective switch elements 20A and 24A of the voltage conversion unit 4A are switched to the ON state, and PWM signals are output to the respective driving switch elements 5A and 6A so that the above-described first and second states are switched. With such control, the voltage conversion unit 4A performs a voltage conversion operation of stepping down a DC voltage applied to the individual input path 42A, and outputting the stepped-down DC voltage to the individual output path 52A. While the voltage conversion unit 4A performs the voltage conversion operation, driving of the other voltage conversion unit 4B is disabled, so that the switch elements 5B and 6B are kept in the OFF state, and the protective switch elements 20B and 24B are kept in the OFF state. The control unit 2 performs such control of driving only the voltage conversion unit 4A for a predetermined time period, and compares, during this predetermined time period, a value Io of the current flowing through the output-side conductive path 72 with the threshold It, and a value Vo of the voltage of the output-side conductive path 72 with the threshold Vt. If the state Io>It or Vo>Vt is given, then it is determined that the voltage conversion unit 4A is abnormal. On the other hand, if the states Io≤It and Vo≤Vt are maintained during the predetermined time period in which only the voltage conversion unit 4A is driven, it is determined that the voltage conversion unit 4A is normal.

Then, in a state in which only the other voltage conversion unit 4B is operated, and the voltage conversion unit 4A is disabled, the control unit 2 determines whether or not either of an overcurrent and an overvoltage has occurred in the power supply conductive path 70. Specifically, the protective switch elements 20B and 24B of the voltage conversion unit 4B are switched to the ON state, and PWM signals are output to the respective driving switch elements 5B and 6B so that the above-described first state and second states are switched. With such control, the voltage conversion unit 4B performs a voltage conversion operation of stepping down a DC voltage applied to the individual input path 42B, and outputting the stepped-down DC voltage to the individual output path 52B. While the voltage conversion unit 4B performs the voltage conversion operation, driving of the voltage conversion unit 4A is disabled, so that the switch elements 5A and 6A are kept in the OFF state, and the protective switch elements 20A and 24A are kept in the OFF state. The control unit 2 performs such control of driving only the voltage conversion unit 4B for a predetermined time period, and compares, during the predetermined time period, a value Io of the current flowing through the output-side conductive path 72 with the threshold It, and a value Vo of the voltage of the output-side conductive path 72 with the threshold Vt. If the state Io>It or Vo>Vt is given, it is determined that the voltage conversion unit 4B is abnormal. On the other hand, if the states Io≤It and Vo≤Vt are maintained during the predetermined time period in which only the voltage conversion unit 4B is driven, it is determined that the voltage conversion unit 4B is normal.

In the present configuration, the control unit 2 corresponds to an example of a driving abnormality identifying unit, and functions to identify, at least after all of the voltage conversion units 4A and 4B are disabled by the disabling control unit, a conversion unit in which at least either a current or a voltage is abnormal from among the plurality of voltage conversion units 4A and 4B constituting the multiphase conversion unit 4.

With such control, if it is determined that either of the voltage conversion units 4A and 4B is abnormal, then the control unit 2 halts the operation of the conversion unit that is determined as being abnormal, and sends predetermined abnormality information via a communication interface 90 to a higher-order system. Then, the control unit 2 causes any remaining conversion unit (of the plurality of voltage conversion units 4A and 4B constituting the multiphase conversion unit 4) other than the conversion unit determined as being abnormal to perform the voltage conversion operation. For example, if it is determined that the voltage conversion unit 4A is abnormal and the voltage conversion unit 4B is normal, the control unit 2 sends information indicating that the voltage conversion unit 4A is abnormal via the communication interface 90 to the higher-order system. Then, the multiphase conversion unit 4 restarts an operation such that the operation of the voltage conversion unit 4A that is determined as being abnormal is halted, and only the remaining voltage conversion unit 4B that is other than the voltage conversion unit 4A performs the voltage conversion operation. Note that, if it is determined that all of the voltage conversion units 4A and 4B are abnormal, the multiphase conversion unit 4 itself is disabled.

In the present configuration, the control unit 2 corresponds to an example of an operation control unit, and functions to cause, if a conversion unit in which at least either a current or a voltage is abnormal is identified by the driving abnormality identifying unit, any remaining conversion unit (of the plurality of voltage conversion units 4A and 4B constituting the multiphase conversion unit 4) other than the conversion unit identified by the driving abnormality identifying unit to perform the voltage conversion operation. Furthermore, the control unit 2 corresponds to an example of a notification unit, and functions to give notice to the outside if part of the voltage conversion operations of the plurality of voltage conversion units 4A and 4B are restricted by the operation control unit.

The following will describe test processing of protective switching elements.

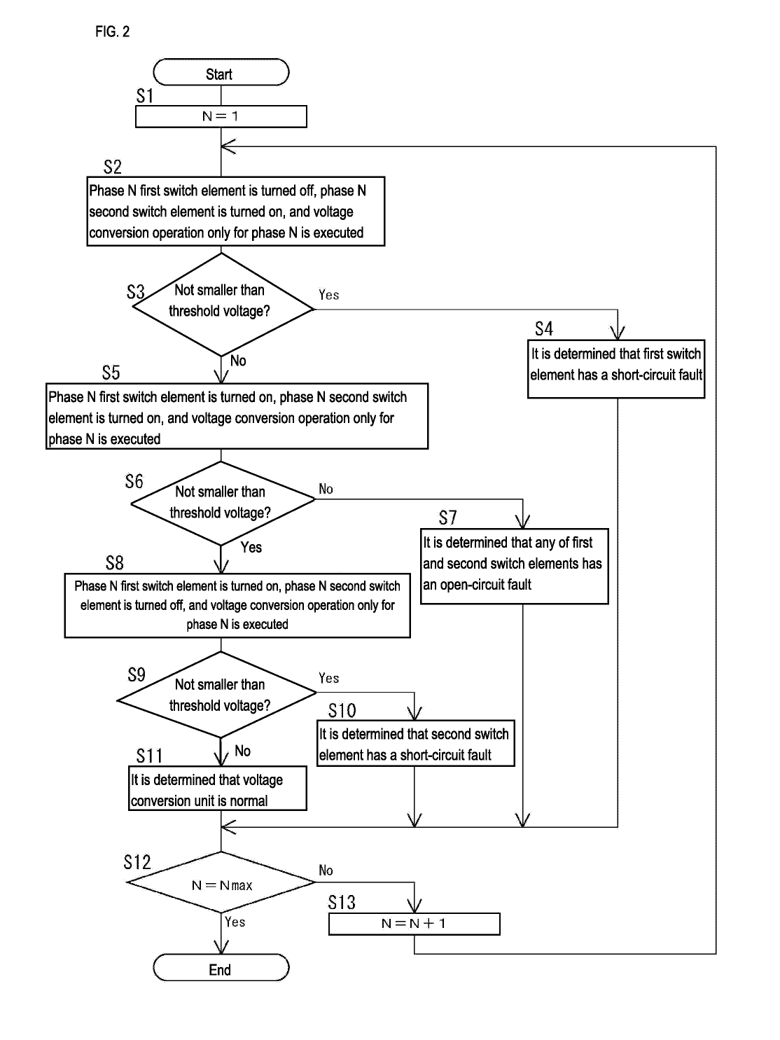

As shown in FIG. 1, an ignition signal from a not-shown ignition switch is input to the control unit 2. The configuration is such that, if the ignition switch is in an ON state, an ignition signal (ON signal) indicating the ON state is input to the control unit 2, and if the ignition switch is in the OFF state, an ignition signal (OFF signal) indicating the OFF state is input to the control unit 2. The control unit 2 performs test processing as shown in FIG. 2 each time the ignition signal is switched from the OFF signal to the ON signal. Specifically, the test processing shown in FIG. 2 may be performed using power supplied from the primary side power supply portion 61, after the ignition signal is switched from the OFF signal to the ON signal and before a not-shown power generator connected to the input-side conductive path 71 is activated. Alternatively, the test processing of FIG. 2 may also be performed, after the ignition signal is switched from the OFF signal to the ON signal, and the not-shown power generator connected to the input-side conductive path 71 is activated.

With the test processing shown in FIG. 2, a protective switch element is tested for each phase in the multiphase conversion unit 4 that has a maximum phase count Nmax (in the example of FIG. 1, Nmax=2). First, in step S1, N=1 is set. Note that “N” is a value that indicates the phase to be tested in the procedure from steps S2 to S12. In the configuration of FIG. 1, when N=1 is set, the voltage conversion unit 4A of a first phase is to be tested.

In step S2, in a state in which an input-side protective switch element (first switch element) of the voltage conversion unit of the phase N is turned off, and an output-side protective switch element (second switch element) thereof is turned on, the voltage conversion operation is performed only for the phase N. For example, for the first time where N=1 is set, the voltage conversion operation of the voltage conversion unit 4A is performed in a state in which the input-side protective switch element 20A of the voltage conversion unit 4A of the first phase is turned off, and the output-side protective switch element 24A thereof is turned on, and the voltage conversion unit 4B is disabled. The voltage conversion operation of the voltage conversion unit 4A at this time is performed with a duty ratio with which a voltage V1 (for example, 14V) that is higher than the output voltage (for example, 12V) of the secondary side power supply portion 62 is output to the individual output path 52A if both of the switch elements 20A and 24A are conductive.

Then, whether or not the voltage that is applied to the output-side conductive path 72 in the voltage conversion operation of step S2 is at least a threshold voltage V2 is determined (step S3). “Threshold voltage V2” has a value that is higher than the output voltage (for example, 12V) from the secondary side power supply portion 62 and is lower than the above-described voltage V1 (voltage that is to be output to the individual output path 52A in the voltage conversion operation of step S2 if both of the switch elements 20A and 24A are conductive). Since the threshold voltage V2 is set in such a manner, and the input-side protective switch element (first switch element) of the phase N is turned off during the voltage conversion operation of step S2, the voltage that is applied to the output-side conductive path 72 if this switch element has been properly turned off should be about as large as the output voltage from the secondary side power supply portion 62, that is, less than the threshold voltage V2. Accordingly, if the voltage that is applied to the output-side conductive path 72 in the voltage conversion operation of step S2 is at least the threshold voltage V2, then in step S3, the procedure advances to “Yes”, and it is determined that the input-side protective switch element (first switch element) of the phase N has a short-circuit fault (step S4). For example, it is determined that the input-side switch element 20A of the voltage conversion unit 4A has a short-circuit fault for N=1.

If the voltage that is applied to the output-side conductive path 72 in the voltage conversion operation of step S2 is smaller than the threshold voltage V2, then in step S3, the procedure advances to “No”, and the processing in step S5 is performed. In step S5, in a state in which the input-side protective switch element (first switch element) of the voltage conversion unit of the phase N is turned on, and the output-side protective switch element (second switch element) thereof is turned on, the voltage conversion operation is performed only for the phase N. For example, for the first time where N=1 is set, the voltage conversion operation of the voltage conversion unit 4A is performed in a state in which the switch element 20A is turned on and the switch element 24A is turned on, and the voltage conversion unit 4B is disabled. The voltage conversion operation of the voltage conversion unit 4A at this time as well is performed with a duty ratio with which the voltage V1 (for example, 14V) that is higher than the output voltage (for example, 12V) of the secondary side power supply portion 62 is output to individual output path 52A if both of the switch elements 20A and 24A are conductive.

Then, whether or not the voltage that is applied to the output-side conductive path 72 in the voltage conversion operation of step S5 is at least the threshold voltage V2 is determined (step S6). The voltage conversion operation of step S5 is performed with the duty ratio with which the voltage V1 that is higher than the threshold voltage V2 is output to the individual output path 52A if both of the switch elements 20A and 24A are conductive. Since, in step S5, both of the input-side and output-side protective switch elements (first and second switch elements) of the phase N are turned on, the voltage that is applied to the output-side conductive path 72 if these switch elements have been properly turned on should be at least the threshold voltage V2. Accordingly, if the voltage that is applied to the output-side conductive path 72 in the voltage conversion operation of step S5 is smaller than the threshold voltage V2, then in step S6, the procedure advances to “No”, and it is determined that either the input-side protective switch element (first switch element) or the output-side protective switch element (second switch element) of the phase N has an open-circuit fault (step S7). For example, it is determined that either the switch element 20A or 24A of the voltage conversion unit 4A has an open-circuit fault for N=1.

If the voltage that is applied to the output-side conductive path 72 in the voltage conversion operation of step S5 is at least the threshold voltage V2, then in step S6, the procedure advances to “Yes”, and the processing in step S8 is performed. In step S8, in a state in which the input-side protective switch element (first switch element) of the voltage conversion unit of the phase N is turned on, and the output-side protective switch element (second switch element) thereof is turned off, the voltage conversion operation is performed only for the phase N. For example, for the first time where N=1, the voltage conversion operation of the voltage conversion unit 4A is performed in a state in which the switch element 20A is turned on, and the switch element 24A is turned off, and the voltage conversion unit 4B is disabled. The voltage conversion operation of the voltage conversion unit 4A at this time as well is performed with a duty ratio with which the voltage V1 (for example, 14V) that is higher than the output voltage (for example, 12V) of the secondary side power supply portion 62 is output to the individual output path 52A, if both of the switch elements 20A and 24A are conductive.

Then, whether or not the voltage that is applied to the output-side conductive path 72 in the voltage conversion operation of step S8 is at least the threshold voltage V2 is determined (step S9). Since, in the voltage conversion operation of step S8, the output-side protective switch element (second switch element) of the phase N is turned off, the voltage that is applied to the output-side conductive path 72 if this switch element has been properly turned off should be about as large as the output voltage from the secondary side power supply portion 62, that is, less than the threshold voltage V2. Accordingly, if the voltage that is applied to the output-side conductive path 72 in the voltage conversion operation of step S8 is at least the threshold voltage V2, then in step S9, the procedure advances to “Yes”, and it is determined that the output-side protective switch element (second switch element) of the phase N has a short-circuit fault (step S10). For example, it is determined that the output-side switch element 24A of the voltage conversion unit 4A has a short-circuit fault for N=1.

If the voltage that is applied to the output-side conductive path 72 in the voltage conversion operation of step S8 is smaller than the threshold voltage V2, then in step S9, the procedure advances to “No”, and it is determined that the input-side and output-side protective switch elements of the phase N voltage conversion unit are intact (step S11). For example, it is determined that both of the switch elements 20A and 24A are intact for N=1.

After step S11, whether or not N has reached the maximum phase count Nmax (“2” in the example of FIG. 1) is determined (step S12), and if N has not reached the maximum phase count Nmax, then in step S12, the procedure advances to “No”, where N is incremented by 1 (step S13), and the procedure from steps S2 onward is performed again with the new N. For example, if N is 2 in step S13, then the procedure returns to step S2, and the voltage conversion unit 4B of the second phase is subjected to the procedure from steps S2 to S12. Then, when the procedure from steps S2 to S12 on all of the phases ends, and it is determined in step S12 that N has ultimately reached Nmax, then the test processing of FIG. 2 is complete.

In the present configuration, the control unit 2 that executes the processing of FIG. 2 corresponds to an example of a protective abnormality identifying unit, and functions to identify at least either a conversion unit in which a protective switch element is abnormal, from among the plurality of voltage conversion units 4A and 4B constituting the multiphase conversion unit 4.

In the test processing shown in FIG. 2, if it is determined that a protective switch element of any conversion unit is abnormal, then the control unit 2 halts the operation of the conversion unit that is determined as being abnormal, and sends predetermined abnormality information via the communication interface 90 to the higher-order system. Then, the control unit 2 causes any remaining conversion unit (of the plurality of voltage conversion units 4A and 4B constituting the multiphase conversion unit 4) other than the conversion unit determined as being abnormal to perform the voltage conversion operation. For example, in the test processing of FIG. 2, if either of the switch elements 20B and 24B constituting the voltage conversion unit 4B is determined as being abnormal, and the switch elements 20A and 24A that constitute the voltage conversion unit 4A are determined as being normal, the control unit 2 sends information indicating that the voltage conversion unit 4B is abnormal via the communication interface 90 to the higher-order system. Then, the multiphase conversion unit 4 restarts an operation such that the operation of the voltage conversion unit 4B that is determined as being abnormal is halted, and only the remaining voltage conversion unit 4A that is other than the voltage conversion unit 4B performs the voltage conversion operation. Note that if both of the voltage conversion units 4A and 4B are determined as being abnormal, then the multiphase conversion unit 4 itself is disabled.

In the present configuration, the control unit 2 corresponds to an example of an operation control unit, and functions to cause, if a conversion unit in which a protective switch element is abnormal is identified by the protective abnormality identifying unit, any remaining conversion unit (of the plurality of voltage conversion units 4A and 4B constituting the multiphase conversion unit 4) other than the conversion unit identified by the protective abnormality identifying unit to perform the voltage conversion operation. Also, the control unit 2 corresponds to an example of a notification unit, and functions to give notice to the outside if part of the voltage conversion operations of the plurality of voltage conversion units 4A and 4B is restricted by the operation control unit.

As described above, the DC-DC converter 1 according to the present configuration is provided with an individual protective switch element for each phase, and thus, if an abnormality has occurred in a phase, the protective switch element easily conducts appropriate protection. Particularly, since each of the voltage conversion units 4A and 4B is provided with the protective switch elements on both input side and output side, it is possible to switch each of the input-side individual input path and the output-side individual output path to the OFF state to protect the voltage conversion unit. Accordingly, a configuration is achieved in which it is possible to perform the protection operation of preventing an electric current from flowing to a voltage conversion unit from the input side, and the protection operation of preventing an electric current from flowing backward to the voltage conversion unit from the output side.

Furthermore, the DC-DC converter 1 having the present configuration is provided with a protective abnormality identifying unit that is configured to identify a conversion unit in which a protective switch element is abnormal, from among the plurality of voltage conversion units 4A and 4B that constitute the multiphase conversion unit 4. Accordingly, it is possible to identify a conversion unit in which a protective switch element is abnormal. The operation control unit is configured to cause, if a conversion unit in which a protective switch element is abnormal has been identified, any remaining conversion unit other than the identified conversion unit to perform a voltage conversion operation. Accordingly, it is possible to continue the operation using the remaining conversion unit while disabling the range in which a protective switch element is abnormal to protect it. Particularly, it is possible to prevent a protective switch element that is abnormal from being used continuously, thus preventing such a situation that, when needed to be turned off during the voltage conversion operation of the multiphase conversion unit 4, a protective switch element of a phase cannot be turned off due to a failure.

Particularly, if a conversion unit in which at least either of the input-side and output-side protective switch elements is abnormal has been identified, it is possible to disable the identified range, and continue the operation using the remaining changing unit(s). With this, of the plurality of voltage conversion units 4A and 4B constituting the multiphase conversion unit 4, only the conversion unit(s) in which no abnormality has occurred on both of the input side and the output side will be used, and the conversion unit(s) to be used is/are easily and reliably subjected to a protection operation for both the input side and the output side when the protection is needed.

Furthermore, the protective abnormality identifying unit is configured to identify, at least if the ignition switch is switched from OFF to ON, any conversion unit in which a protective switch element is abnormal, with the plurality of voltage conversion units 4A and 4B that constitute the multiphase conversion unit 4 serving as a detection target. According to this configuration, after the ignition switch has been switched from OFF to ON, a range in which a protective switch element is abnormal can be identified more promptly in an earlier stage after the activation.

Furthermore, the DC-DC converter 1 having the present configuration is provided with a disabling control unit, and thus, if an abnormality has occurred during the operation of the multiphase conversion unit 4, it is possible to temporarily disable all of the voltage conversion units to conduct prompt protection. Particularly, the disabling control unit is configured to perform control such that, if it is detected by the detection unit that an abnormality has occurred in the multiphase conversion unit 4 during the operation of the multiphase conversion unit 4, the protective switch elements of all of the voltage conversion units 4A and 4B are switched to the OFF state. According to this configuration, even if a fault such as a short circuit has occurred in a driving switch element of any voltage conversion unit, it is possible to reliably disable the voltage conversion units by turning off the protective switch elements provided in the respective voltage conversion units.

The present configuration is such that, if an abnormality has occurred during the operation of the multiphase conversion unit 4, the disabling control unit disables all of the voltage conversion units, and then the driving abnormality identifying unit identifies a range of abnormality. Thus, the identification of the range of abnormality is performed in a state in which the multiphase conversion unit 4 is better protected. Also, the operation control unit is configured to cause, if a range of abnormality is identified by the driving abnormality identifying unit, any remaining conversion unit (of the plurality of voltage conversion units 4A and 4B constituting the multiphase conversion unit 4) other than the conversion unit identified by the driving abnormality identifying unit to perform a voltage conversion operation. Accordingly, it is possible to continue the operation using the remaining conversion unit while reliably continuing disabling the range of abnormality to protect it.

In the DC-DC converter 1 having the present configuration, the secondary side power supply portion 62 (power storage unit) is connected to the output-side conductive path 72. According to this configuration, even if an abnormality has occurred during the operation of the multiphase conversion unit 4, and all of the voltage conversion units 4A and 4B are disabled temporarily, a voltage will continuously be output to the output-side conductive path 72 from the secondary side power supply portion 62 (power storage unit). Therefore, a configuration is achieved in which all of the voltage conversion units 4A and 4B can be disabled if an abnormality has occurred during the operation of the multiphase conversion unit 4, and power supply to the output-side conductive path 72 can be continued even while they are disabled.

The DC-DC converter 1 having the present configuration is provided with a notification unit configured to give notice to the outside if part of the voltage conversion operations of the plurality of voltage conversion units 4A and 4B is restricted by the operation control unit. According to this configuration, if part of the voltage conversion operations of the plurality of voltage conversion units 4A and 4B is restricted, an external device can recognize the situation, and can perform processing that corresponds to the restriction.

### Other Embodiments

The present invention is not limited to the embodiments described with reference to the description above and the drawings, and the technical scope of the present invention encompasses, for example, the following embodiments.

(1) The specific examples of the primary side power supply portion 61 and the secondary side power supply portion 62 in the above-described embodiments are merely examples, and the types of the electrical storage means and generated voltages may vary without being limited to the above-described examples.

(2) In the example of FIG. 1, the power generator, loads, and the like that are connected to the input-side conductive path and the output-side conductive path are omitted, but various devices and electric members may be connected to the input-side conductive path and the output-side conductive path.

(3) In Embodiment 1, a configuration in which the switch elements 6A and 6B are provided on the low side is shown as an example, but a configuration in which these elements are replaced by diodes is also possible.

(4) The control unit 2 shown in FIG. 1 may also be configured to be able to determine whether an electric current is flowing through the output-side conductive path 72 in a first direction from the multiphase conversion unit 4 side toward the secondary side power supply portion 62 side, or a second direction from the secondary side power supply portion 62 side toward the multiphase conversion unit 4 side. The control unit 2 may also be configured, if it is detected that the electric current is flowing through the output-side conductive path 72 in the above-described “second direction” (that is, if it is determined that the direction of the electric current is a back flow), to switch both of the protective switch elements 24A and 24B to the OFF state. Alternatively, the control unit 2 may also be configured, if it is detected that the electric current is flowing through the output-side conductive path 72 in the above-described “second direction”, to disable all of the voltage conversion units 4A and 4B temporarily, and then individually activate the conversion units to identify a conversion unit that is abnormal. The control unit 2 may also be configured, if a conversion unit that is abnormal has been identified, to restart the operation to cause only the remaining conversion unit(s) other than the abnormal conversion unit to perform a voltage conversion operation.

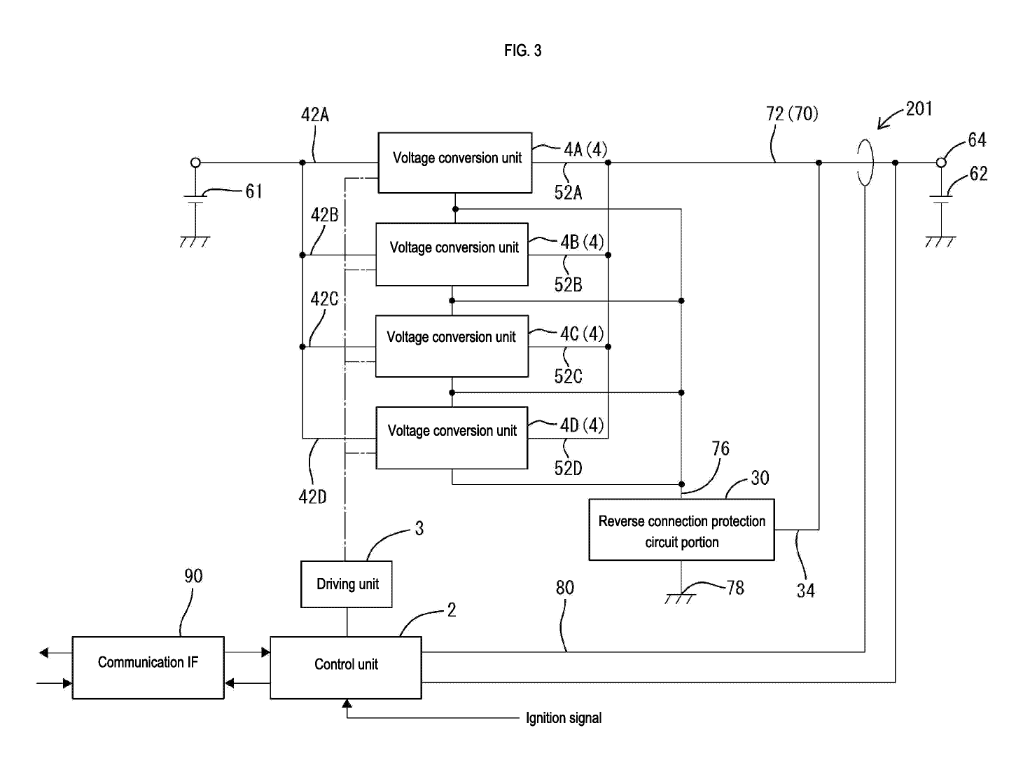

(5) In Embodiment 1, a two-phase structure DC-DC converter 1 in which two voltage conversion units 4A and 4B are connected in parallel to each other is shown, but a DC-DC converter 1 of a structure with three or more phases in which three or more voltage conversion units are connected in parallel to each other may also be used. For example, a four-layer structure DC-DC converter 201 as shown in FIG. 3 may be used. The DC-DC converter 201 of FIG. 3 differs from the DC-DC converter 1 of FIG. 1 in that, in addition to the voltage conversion units 4A and 4B, voltage conversion units 4C and 4D are connected in parallel to each other. Other features are the same as those of the DC-DC converter 1 of FIG. 1. The voltage conversion units 4C and 4D respectively have the same structures as those of the voltage conversion units 4A and 4B.

(6) In Embodiment 1, if an abnormality has occurred during the operation of the multiphase conversion unit 4, the control unit 2 that corresponds to the disabling control unit disables all of the voltage conversion units, and then the control unit 2 that corresponds to the driving abnormality identifying unit identifies a conversion unit that is abnormal from among the plurality of voltage conversion units constituting the unit multiphase conversion unit 4, but the control unit 2 that corresponds to the driving abnormality identifying unit may also be configured to identify a group including a conversion unit that is abnormal. The following will describe an example thereof.

For example, in the DC-DC converter 201 as shown in FIG. 3, if an overcurrent or an overvoltage as described above has occurred in the output-side conductive path 72, that is, if the state Io>It or Vo>Vt is given, then the control unit 2 that corresponds to the disabling control unit will disable temporarily all of the voltage conversion units 4A, 4B, 4C, and 4D, and then will perform processing for identifying a range of abnormality. In this identification processing, first, the control unit 2 performs first control of causing a group of the voltage conversion units 4A and 4B to perform the voltage conversion operations, and disabling the voltage conversion operations of a group of the voltage conversion units 4C and 4D. In this first control, if an overcurrent or an overvoltage has occurred in the output-side conductive path 72, that is, if the state Io>It or Vo>Vt is given, the group of the voltage conversion units 4A and 4B is identified as a “group including an abnormal conversion unit”. In contrast, in the first control, if neither an overcurrent nor an overvoltage has occurred in the output-side conductive path 72, then the group of the voltage conversion units 4A and 4B is identified as a “group of only normal conversion units”.

After the first control, then, the control unit 2 performs second control of disabling the voltage conversion operations of the group of the voltage conversion units 4A and 4B, and causing the group of the voltage conversion units 4C and 4D to perform the voltage conversion operations. In this second control, if an overcurrent or an overvoltage has occurred in the output-side conductive path 72, that is, if the state Io>It or Vo>Vt is given, the group of the voltage conversion units 4C and 4D is identified as the “group including an abnormal conversion unit”. In contrast, in the second control, if neither an overcurrent nor an overvoltage has occurred in the output-side conductive path 72, then the group of the voltage conversion units 4C and 4D is identified as the “group of only normal conversion units”. The control unit 2 identifies the “group including an abnormal conversion unit”, and then restarts the voltage conversion operation of the multiphase conversion unit 4 so that any remaining conversion unit other than the “group including an abnormal conversion unit” performs the voltage conversion operation.

In this configuration, the control unit 2 corresponds to an example of a driving abnormality identifying unit, and functions to identify, after all of the voltage conversion units are disabled by the disabling control unit, a “group including an abnormal conversion unit” from among the plurality of voltage conversion units 4A, 4B, 4C, and 4D constituting the multiphase conversion unit 4. Also, the control unit 2 corresponds to an example of an operation control unit, and functions to cause, if the “group including an abnormal conversion unit” is identified by the driving abnormality identifying unit, the remaining conversion units that are other than the “group including an abnormal conversion unit” identified by the driving abnormality identifying unit to perform voltage conversion operations, the remaining conversion units being included in the plurality of voltage conversion units 4A, 4B, 4C, and 4D that constitute the multiphase conversion unit 4.

(7) In Embodiment 1, a “conversion unit in which a protective switch element is abnormal” is identified in the test processing of FIG. 2, but a “group including a conversion unit in which a protective switch element is abnormal” may be identified. Specifically, it is possible to perform test processing in the following manner.

For example, when test processing of the DC-DC converter 201 is performed as shown in FIG. 3, a first test operation is first executed. In this first test operation, the voltage conversion operations of the voltage conversion units 4A and 4B of the first and second phases are executed in a state in which both of the input-side protective switch elements (the same elements as the switch elements 20A and 20B shown in FIG. 1) of the voltage conversion units 4A and 4B are turned off, and both of the output-side protective switch elements (the same elements as the switch elements 24A and 24B shown in FIG. 1) thereof are turned on. The voltage conversion operations of the voltage conversion units 4A and 4B at this time are executed with a duty ratio with which the voltage V1 (for example, 14V) that is higher than the output voltage (for example, 12V) of the secondary side power supply portion 62 is output to the output-side conductive path 72 if all of the protective switch elements (the same elements as the switch elements 20A, 20B, 24A, and 24B shown in FIG. 1) are conductive. Note that the voltage conversion units 4C and 4D of the third and fourth phases are disabled, and all of their protective switch elements are turned off. If, as described above, the voltage of the output-side conductive path 72 is at least the threshold voltage V2 during the voltage conversion operation, it is determined that any of the input-side protective switch elements of the voltage conversion units 4A and 4B has a short-circuit fault. Note that “threshold voltage V2” has a value that is higher than the output voltage (for example, 12V) from the secondary side power supply portion 62, and is lower than the above-described voltage V1 (voltage to be output to the output-side conductive path 72 in the above-described voltage conversion operation if all of the protective switch elements of the voltage conversion units 4A and 4B are conductive).

Then, a second test operation is executed. In this second test operation, the voltage conversion operations of the voltage conversion units 4A and 4B of the first and second phases are executed in a state in which both of the input-side protective switch elements of the voltage conversion units 4A and 4B are turned on, and both of the output-side protective switch elements thereof are turned off. Note that the voltage conversion units 4C and 4D of the third and fourth phases are disabled, and all of their protective switch elements are turned off. Setting of a duty ratio in the second test operation is configured in the same manner as in the first test operation, and a threshold voltage is set to the same one as that of the first test operation. Accordingly, if the voltage of the output-side conductive path 72 is at least threshold voltage V2 during the voltage conversion operation, it is determined that any of the output-side protective switch elements of the voltage conversion units 4A and 4B has a short-circuit fault.

Then, a third test operation is executed. In this third test operation, the voltage conversion operations of the voltage conversion units 4A and 4B of the first and second phases are executed in a state in which all of the input side and output-side protective switch elements of the voltage conversion units 4A and 4B are turned on. Note that the voltage conversion units 4C and 4D of the third and fourth phases are disabled, and all of their protective switch elements are turned off. Setting of a duty ratio in the third test operation is configured in the same manner as in the first test operation, and a threshold voltage is set to the same one as that of the first test operation. Accordingly, if the voltage of the output-side conductive path 72 is smaller than threshold voltage during the voltage conversion operation, it is determined that any of the protective switch elements of the voltage conversion units 4A and 4B has an open-circuit fault.

As a result of such determination, if a short-circuit fault or an open-circuit fault has been detected, the voltage conversion units 4A and 4B of the first and second phases are determined as a “group including a conversion unit in which a protective switch element is abnormal”, and if neither a short-circuit fault nor an open-circuit fault has been detected, the voltage conversion units 4A and 4B of the first and second phases are determined as a “group of normal conversion units”. In such a way, it is possible to determine whether or not the group of the voltage conversion units 4A and 4B of the first and second phases is a “group including a conversion unit in which a protective switch element is abnormal”. Also, by subjecting the voltage conversion units 4C and 4D of the third and fourth phases to the above-described first to third test operations in the same way, it is possible to determine whether or not the group of the voltage conversion units 4C and 4D of the third and fourth phases is a “group including a conversion unit in which a protective switch element is abnormal”. In this example, the control unit 2 corresponds to an example of a protective abnormality identifying unit, and functions to identify a “group including a conversion unit in which a protective switch element is abnormal”.

Also, the control unit 2 corresponds to an example of an operation control unit, and functions to operate the multiphase conversion unit 4 such that, if a “group including a conversion unit in which a protective switch element is abnormal” is identified by the protective abnormality identifying unit, the remaining conversion units that are other than the “group including a conversion unit in which a protective switch element is abnormal” identified by the driving abnormality identifying unit to perform voltage conversion operations, the remaining conversion units being included in the plurality of voltage conversion units 4A, 4B, 4C, and 4D that constitute the multiphase conversion unit 4.

(8) Embodiment 1 has a configuration in which test processing shown in FIG. 2 is executed each time the ignition signal is switched from an OFF signal to an ON signal, but the test processing may also be executed at another timing. The test processing shown in FIG. 2 may also be executed at a timing at which, during the normal operation of the multiphase conversion unit 4, an abnormality such as an overcurrent, an overvoltage, a back flow, or an overheat has occurred in the multiphase conversion unit 4.

(9) In Embodiment 1, when the ignition switch is switched from OFF to ON, a “conversion unit in which a protective switch element is abnormal” is detected in a flow as shown in FIG. 2 with the plurality of voltage conversion units 4A and 4B constituting the multiphase conversion unit 4 serving as a detection target, but a configuration is also possible in which a conversion unit serving as a detection target or a group including a conversion unit serving as a detection target are switched each time the ignition switch is switched from OFF to ON. For example, at a time at which the ignition switch is switched from OFF to ON, the processing from steps S2 to S11 of FIG. 2 is executed with only one voltage conversion unit 4A serving as a test target, and in steps S4, S7, and S10, if it is determined that there is an abnormality, then the operation of the voltage conversion unit 4A is halted, and only the voltage conversion unit 4B is operated, and in step S11, if it is determined that the conversion unit is normal, then both of the voltage conversion units 4A and 4B are operated.

Then, at a time at which the ignition switch is switched from OFF to ON, the processing from steps S2 to S11 of FIG. 2 is executed with only the voltage conversion unit 4B, instead of the voltage conversion unit 4A that has been previously tested, serving as a test target. In steps S4, S7, and S10, if it is determined that there is an abnormality, then the operation of the voltage conversion unit 4B is halted, and the voltage conversion unit 4A is operated to execute voltage conversion if the voltage conversion unit 4A was determined as being normal in the previous test. If the voltage conversion unit 4A was determined as being abnormal in the previous test, the multiphase conversion unit 4 itself is disabled. In contrast, in step S11, if it is determined that the voltage conversion unit 4A is normal, both of the voltage conversion units 4A and 4B are operated if the voltage conversion unit 4A was determined as being normal in the previous test. If the voltage conversion unit 4A was determined as being abnormal in the previous test, then the voltage conversion unit 4A is kept disabled, and only the voltage conversion unit 4B is operated.

Then, at a time at which the ignition switch is next switched from OFF to ON, the processing from steps S2 to S11 of FIG. 2 is executed with only the voltage conversion unit 4A, instead of the voltage conversion unit 4B that has been previously tested, serving as a test target. Accordingly, whether or not it is a “conversion unit in which a protective switch element is abnormal” is tested with the conversion unit serving as a test target changed each time the ignition switch is switched form OFF to ON.

With this, it is possible to suppress a check time that is involved in a single ON operation of the ignition switch. Furthermore, since it is possible to check a plurality of voltage conversion units cydopaedically using a plurality of times of ON operations of the ignition switch, it is possible to prevent such a situation that a voltage conversion unit is not checked for a long time.

(10) In the configuration of Embodiment 1, a power storage state detection unit for detecting that the secondary side power supply portion 62 (power storage unit) is in a predetermined normal state may also be provided. The power storage state detection unit may also be realized by the control unit 2, and a separate battery sensor or the like may also be provided.

For example, a configuration is such that the control unit 2 functions as the power storage state detection unit, and is configured to determine that the secondary side power supply portion 62 (power storage unit) is in the predetermined normal state if a voltage of the output-side conductive path 72 at a time at which the multiphase conversion unit 4 is disabled is equal to or higher than a predetermined voltage, and otherwise determine that the secondary side power supply portion 62 (power storage unit) is in an abnormal state. In such a configuration, if an overcurrent or an overvoltage has been detected during the normal operation of the multiphase conversion unit 4, that is, if the state Io>It or Vo>Vt is given, then it is sufficient that all of the voltage conversion units 4A and 4B of the multiphase conversion unit 4 are disabled, and then the above-described processing for identifying a “conversion unit that is abnormal” is executed only if the secondary side power supply portion 62 (power storage unit) is determined as being in the predetermined normal state.

Accordingly, with a configuration in which all of the voltage conversion units of the multiphase conversion unit are disabled if the power storage unit is in the predetermined normal state, it is possible to reliably prevent the situation in which power supply to the output-side conductive path is interrupted due to an abnormality in the power storage unit when the multiphase conversion unit is disabled.

Alternatively, a configuration is also possible in which the normal operation of the multiphase conversion unit 4 is executed only if the secondary side power supply portion 62 (power storage unit) is determined as being in the “predetermined normal state”. In such a configuration, even if all of the voltage conversion units 4A and 4B of the multiphase conversion unit 4 are disabled when an overcurrent or an overvoltage has been detected during the normal operation of the multiphase conversion unit 4, the likelihood in which power is supplied from the power storage unit to the output-side conductive path is high.

1. A DC-DC converter comprising:
a multiphase conversion unit that is provided with a plurality of voltage conversion units that are arranged between an input-side conductive path and an output-side conductive path, each voltage conversion unit including an individual input path connected to the input-side conductive path, a conversion operation portion configured to convert a voltage input to the individual input path using an on/off operation of a driving switch element, and an individual output path serving as an output path for the voltage converted by the conversion operation portion, each voltage conversion unit being provided with, on at least one of the individual input path and the individual output path, a protective switch element configured to switch the corresponding individual input or output path between a conductive state and a non-conductive state;
a detection unit configured to detect that an abnormality has occurred in the multiphase conversion unit at least during an operation of the multiphase conversion unit;
a disabling control unit configured to disable all of the voltage conversion units of the multiphase conversion unit if the occurrence of an abnormality in the multiphase conversion unit is detected by the detection unit during the operation of the multiphase conversion unit;
a driving abnormality identifying unit configured to identify, at least after all of the voltage conversion units are disabled by the disabling control unit, a conversion unit that is abnormal or a group including a conversion unit that is abnormal from among the plurality of voltage conversion units that constitute the multiphase conversion unit; and
an operation control unit configured to cause, if a conversion unit that is abnormal or a group including a conversion unit that is abnormal is identified by the driving abnormality identifying unit, any remaining conversion unit other than the conversion unit or the group including the conversion unit that has been identified by the driving abnormality identifying unit to perform a voltage conversion operation.

2. A DC-DC converter comprising:
a multiphase conversion unit that is provided with a plurality of voltage conversion units that are arranged between an input-side conductive path and an output-side conductive path, each voltage conversion unit including an individual input path connected to the input-side conductive path, a conversion operation portion configured to convert a voltage input to the individual input path using an on/off operation of a driving switch element, and an individual output path serving as an output path for the voltage converted by the conversion operation portion, each voltage conversion unit being provided with, on at least one of the individual input path and the individual output path, a protective switch element configured to switch the corresponding individual input or output path between a conductive state and a non-conductive state;
a protective abnormality identifying unit configured to identify at least either a conversion unit in which a protective switch element is abnormal, or a group including a conversion unit in which a protective switch element is abnormal, from among the plurality of voltage conversion units that constitute the multiphase conversion unit; and
an operation control unit configured to cause, if a conversion unit in which a protective switch element is abnormal or a group including a conversion unit in which a protective switch element is abnormal is identified by the protective abnormality identifying unit, any remaining conversion unit other than the conversion unit or the group including the conversion unit that has been identified by the protective abnormality identifying unit to perform a voltage conversion operation.

3. The DC-DC converter according to claim 2,
wherein each of the voltage conversion units constituting the multiphase conversion unit is provided with protective switch elements on its individual input path and individual output path, and
the protective abnormality identifying unit is configured to identify a conversion unit in which at least one of the protective switch elements is abnormal, or a group including a conversion unit in which at least one of the protective switch elements is abnormal, from among the plurality of voltage conversion units constituting the multiphase conversion unit.

4. The DC-DC converter according to claim 2,
wherein the protective abnormality identifying unit is configured to identify, at least when an ignition switch is switched from OFF to ON, a conversion unit in which a protective switch element is abnormal, or a group including a conversion unit in which a protective switch element is abnormal with a subset or all of the plurality of voltage conversion units constituting the multiphase conversion unit serving as a detection target.

5. The DC-DC converter according to claim 4,
wherein the protective abnormality identifying unit is configured to detect, when the ignition switch is switched from OFF to ON, a conversion unit in which a protective switch element is abnormal, or a group including a conversion unit in which a protective switch element is abnormal, with a subset of the plurality of voltage conversion units constituting the multiphase conversion unit serving as a detection target, and is configured to switch the conversion unit serving as a detection target or the group including a conversion unit serving as a detection target each time the ignition switch is switched from OFF to ON.

6. The DC-DC converter according to claim 2, comprising:
a detection unit configured to detect that an abnormality has occurred in the multiphase conversion unit at least during an operation of the multiphase conversion unit;
a disabling control unit configured to disable all of the voltage conversion units of the multiphase conversion unit if the occurrence of an abnormality in the multiphase conversion unit is detected by the detection unit during the operation of the multiphase conversion unit; and
a driving abnormality identifying unit configured to identify, at least after all of the voltage conversion units are disabled by the disabling control unit, a conversion unit that is abnormal or a group including a conversion unit that is abnormal from among the plurality of voltage conversion units that constitute the multiphase conversion unit,
wherein the operation control unit is configured to cause, if a conversion unit that is abnormal or a group including a conversion unit that is abnormal is identified by the driving abnormality identifying unit, any remaining conversion unit other than the conversion unit or the group including the conversion unit that has been identified by the driving abnormality identifying unit to perform a voltage conversion operation.

7. The DC-DC converter according to claim 1,
wherein the disabling control unit is configured to perform control such that, if the occurrence of an abnormality in the multiphase conversion unit is detected by the detection unit during the operation of the multiphase conversion unit, the protective switch elements that are respectively provided in all of the voltage conversion units are switched to an OFF state.

8. The DC-DC converter according to claim 1,
wherein a power storage unit is connected to the output-side conductive path.

9. The DC-DC converter according to claim 1, comprising:
a notification unit configured to give notice to the outside if at least one of the voltage conversion units of the multiphase conversion unit is restricted by the operation control unit.
